(19) United States
(12) Patent Application Publication
(10) Pub. No.: US 2025/0148512 A1
(43) Pub. Date: May 8, 2025

(54) SYSTEMS AND METHODS FOR IDENTIFICATION OF CORPORATE TARGETS BASED ON SOCIAL MEDIA CONTENT

(71) Applicant: Telemetry, LLC, Los Angeles, CA (US)

(72) Inventors: David Freeman Ford, Los Angeles, CA (US); Laura Baldwin Flowerree, Tiburon, CA (US); Jonathan Chung-Yin Wu, San Jose, CA (US); Lauren Ashlee Schwarz, San Diego, CA (US)

(21) Appl. No.: 18/933,544

(22) Filed: Oct. 31, 2024

Related U.S. Application Data
(60) Provisional application No. 63/596,111, filed on Nov. 3, 2023.

(51) Int. Cl. G06Q 30/0282; G06Q 50/00

(52) U.S. Cl. CPC G06Q 30/0282; G06Q 50/01

(57) ABSTRACT

Systems and methods for identifying corporate targets based on social media content are disclosed. Users of a social media platform include individuals and companies. Each user has a user profile. For each individual, processor(s) generate individual data terms from the user profile and identify a current employer. For each company, the processor(s) generate company data terms from the user profile and add the individual data terms of the individuals for which the company is identified as the current employer to the company data terms. For each combination of company and company data term, the processor(s) generate a frequency score. The processor(s) identify seed companies, candidate companies, and data-type(s)-of-interest. For each data-type-of-interest, the processor(s) calculate a respective similarity score for each combination of seed company and candidate company. The processor(s) determine the target companies based on similarity scores of each candidate company.

### CROSS-REFERENCE TO RELATED APPLICATION

This application claims the benefit of U.S. Provisional Patent Application No. 63/596,111, filed on Nov. 3, 2023, which is incorporated herein by reference in its entirety.

### TECHNICAL FIELD

The present disclosure generally relates to corporate transactions and, more specifically, to systems and methods for identification of corporate targets based on social media content.

### BACKGROUND

Companies have merged with and/or acquired other companies for decades, if not centuries. With mergers, two or more companies consolidate into one company. Whereas, with acquisitions, one company acquires the capital, equity, and/or assets of another company. A company may look to merge with, acquire, or be acquired by another company for a number of reasons. For instance, a company may consider a merger or acquisition to improve its economy of scale, cross-selling, and/or synergy. Additionally or alternatively, a company may consider a merger or acquisition for diversification, vertical integration, and/or for absorption of competing companies, products, and/or services.

Additionally, analytics have become increasingly prevalent in the corporate world. Analytics is a technical field in which advanced computational analysis is performed on data to identify and communicate meaningful information and/or patterns within the data. Companies have used analytics to develop a better understanding of the performance of company portfolios, how companies are managed, how employees work, demographics for marketing campaigns, risk assessment, market strategies, etc.

Even with analytics, it has become increasingly difficult to identify other companies for potential mergers and/or acquisitions due to the ongoing globalization of the world economy. Companies now emerge in different countries across different continents with a wide range of different native languages. That is, with the globalization of the economy, it has become ever more challenging to collect detailed company information that may be of value when attempting to identify potential targets for a merger or acquisition. Moreover, with private startups, which may not be subject to regulatory public disclosure obligations, becoming well-funded and growing more quickly, it is difficult to collect detailed information of companies disrupting markets of interest.

### SUMMARY

Example embodiments are disclosed for systems and methods for identification of corporate targets based on social media content. The present document discloses aspects of the embodiments and should not be used to limit corresponding claims. Other implementations are contemplated in accordance with the techniques described herein, as will be apparent to one having ordinary skill in the art upon examination of the following drawings and detailed description, and these implementations are intended to be within the scope of this application.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example environment in which corporate targets are identified based on social media content.

FIG. 2 is a block diagram of an example system for identifying corporate targets based on social media content in accordance with the teachings herein.

FIG. 3 is an example flowchart for identifying corporate targets based on social media content in accordance with the teachings herein.

FIG. 4 is an example sub-flowchart of the flowchart of FIG. 3 for updating a reference database.

FIG. 5 is an example sub-flowchart of the flowchart of FIG. 4 for generating individual reference data for the reference database.

FIG. 6 is an example sub-flowchart of the flowchart of FIG. 4 for generating company reference data for the reference database.

FIG. 7 is an example sub-flowchart of the flowchart of FIG. 4 for ranking data terms in the reference database.

FIG. 8 is an example sub-flowchart of the flowchart of FIG. 4 for flagging feature keywords in and generating keywords scores for the reference database.

FIG. 9 is an example sub-flowchart of the flowchart of FIG. 3 for identifying corporate targets using the reference database.

FIG. 10 depicts example social media content of an individual used to identify corporate targets.

FIG. 11 depicts other example social media content pf an individual used to identify corporate targets.

FIG. 12 depicts example social media content of a company used to identify corporate targets.

FIG. 13 depicts an example network graph generated to identify corporate targets based on social media content.

### DETAILED DESCRIPTION

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Example systems and methods disclosed herein automatically identify corporate targets for a searching company based on social media content of companies and individuals collected from a social media platform.

As used herein, a “social media platform” refers to an interactive website and/or an app in which users may share content and/or connect with each other. Example social media platforms include YouTube®, TikTok®, and LinkedIn®. Users may include individuals and/or companies. As used herein, “social media content” refers to information and/or other content shared by user(s) on a social media platform. Example social media content includes text-based content, visual-based content, audio-based content, etc.

As used herein, a “social networking platform” refers to a type of a social media platform in which users may generate a profile and/or connect with each other. The connections or network of one user may be viewable by other users. Example social networking platforms include Facebook®, Twitter®, and LinkedIn® Users of a social networking platform may include individuals and/or companies. For instance, users of LinkedIn® include individuals (e.g., employees) and companies (e.g., employers), with profiles of individuals including employment history (e.g., employer names, job titles, employment durations, etc.), qualifications, contact information, etc. and profiles of companies including company descriptions, specialties, contact information, etc.

Social media platforms are now widely used across the globe by both individuals and companies alike. For instance, LinkedIn®, a business- and employment-focused social networking platform, has more than 900,000,000 users across more than 200 countries. These users include both individuals (e.g., employees) and companies (e.g., employers), with each user having a profile that details their connections to other individuals and companies. That is, a business-focused social media platform, such as LinkedIn®, may be a single source of detailed information for a large number of companies across the globe. However, because of the large amount of data that is present for hundreds of millions of users, the data on social networking platforms can be unwieldly, even for some of the most powerful analytic tools.

Examples systems and methods disclosed herein are capable of analyzing the large amounts of content available on a social media platform, such as LinkedIn®, to automatically identify corporate targets for a searching company. To identify corporate targets in such a manner, the examples disclosed herein automatically generate new reference data based on the collected social media content, automatically generate new target data based on the generated reference data and identified seed companies, and identify corporate targets based on the generated target data. To generate the reference data, the examples collect social media data of individuals and companies on the social media platform, clean and standardize the collected social media data into a searchable form, associate data of current employees with current employers, and score and rank each data term of each data type for each company. To generate the target data, the examples disclosed herein identify seed companies, identify a pool of candidate companies based on identified prerequisites, and generate similarity score(s) for each combination of the seed companies and the candidate companies. The corporate targets are then identified based on a review of the similarity scores. In some examples, feature keywords also are used to facilitate identification of corporate targets. Thus, the examples disclosed herein include an unconventional and specific set of rules to generate new data based on social media content and then analyze the generated data to accurately identify corporate targets in an automated manner, which has not been and likely would not otherwise be implemented by those in search of corporate analytic tools.

As used herein, a “searching company” refers a company that is searching for one or more target companies. Example searching companies may be targeting corporate transactions, corporate partnerships, customers, talent acquisitions, competitive landscapes, benchmarking, etc.

As used herein, a “target company” and a “corporate target” refer to a company identified as being a target for a searching company. Target companies are candidate companies that have been compared to seed companies and identified as targets based on similarities to those seed companies. Example target companies may include targets for corporate transactions. As used herein, a “corporate transaction” refers to a merger or acquisition. An example corporate transaction involves one company (e.g., a searching company) merging with, acquiring, or being acquired by another company (e.g., a target company). Example target companies may include corporate partnership targets for a strategic partnership between a searching company and a target company. Example target companies may include potential customers of a searching company. Target companies may be identified for talent acquisitions. For example, a searching company may identify a CEO it would like to target by (1) identifying a target company and (2) identifying the CEO of that target company. Example target companies may include competitive landscape companies and/or benchmarking companies for subsequent comparison to a searching company.

As used herein, a “seed company” refers to a company that has been identified as representative of the type of company a searching company would like to target (e.g., for a corporate transaction, for a corporate partnership, as a customer, for a talent acquisition, for a competitive landscape, for benchmarking, etc.). Example seed companies may have one or more characteristics (e.g., size, industry, location, revenue, etc.) of interest to the searching company. Example seed companies may also be theoretical companies that are composites of one or more characteristics of interest. Example seed companies may also be historical snapshots of companies at a previous periods of time (e.g., Amazon® in 2008). The seed companies may be provided by the searching company and/or identified by another party (e.g., a target-identification system).

As used herein, a “candidate company” refers to a company that satisfies one or more prerequisites for comparison to one or more seed companies. Example prerequisites include geographic location, employee count, etc. The prerequisites may be provided by the searching company and/or identified by another party (e.g., a target-identification system).

As used herein, “social media data” refers to information collected from social media platform(s), such as social networking platform(s), that indicate how users of those social media platform(s) view, comment on, share, and/or otherwise engage with content and/or profiles of other users. Example social media data includes profile information, connections, etc. of a user, such as an individual or a company. Social media data may be obtained from an operating company of a social media platform, the social media platform via scraping, obtained from third-party vendor(s), etc.

As used herein, “reference data” refers to data organized to facilitate comparisons between seed companies and candidate companies. Reference data is generated from social media data associated with companies and individuals. Example reference data corresponds to companies (e.g., employers), such as seed companies and other companies (e.g., potential candidate companies), and individuals associated with those companies (e.g., as employees). Reference data may include flags and/or keyword scores corresponding to one or more feature keywords.

As used herein, a “feature keyword” refers to a word or short phrase associated with a feature of a company and/or individual. As used herein, a “flag” refers to an indicator that a corresponding data term (e.g., in the reference data, in target data) matches and/or otherwise corresponds with the feature associated with the corresponding feature keyword.

As used herein, a “keyword score” is a numerical value indicative of a degree to which a corresponding company and/or individual is associated with a corresponding feature keyword. The keyword score may be a whole number indicative of a numerical count of data terms (e.g., 1, 2, 3, etc.) of a corresponding company and/or individual that match and/or otherwise correspond with the corresponding feature keyword. The keyword score may be a normalized value (e.g., ranging between 0 and 1, ranging between 0 and 100, etc.) that is indicative as to how prevalent the feature keyword is for a corresponding company and/or individual compared to the prevalence of the feature keyword for other companies and/or individuals.

As used herein, a “frequency score” refers to a score indicative of how often a data term is included in the reference data for a particular company. Example frequency scores include n-gram count scores of matches and term frequency—inverse document frequency (TF-IDF) scores. As used herein, a “similarity score” refers to a score indicative of how similar data terms of a seed company are to that of a candidate company. Example similarity scores include cosine similarity scores and n-gram overlap scores.

As used herein, a “target data” refers to data that facilitates identification of one or more target companies from a pool of candidate companies for a searching company. Example target data may indicate how similar or dissimilar each candidate company is to each seed company. Target data may also include flags and/or keyword scores corresponding to one or more feature keywords. The target data may be delivered to the searching company in the form of a report. The report may include identification of a recommended target company, a list of target companies, one or more charts comparing the seed companies to one or more candidate companies, a network graph with the seed companies and one or more candidate companies, etc.

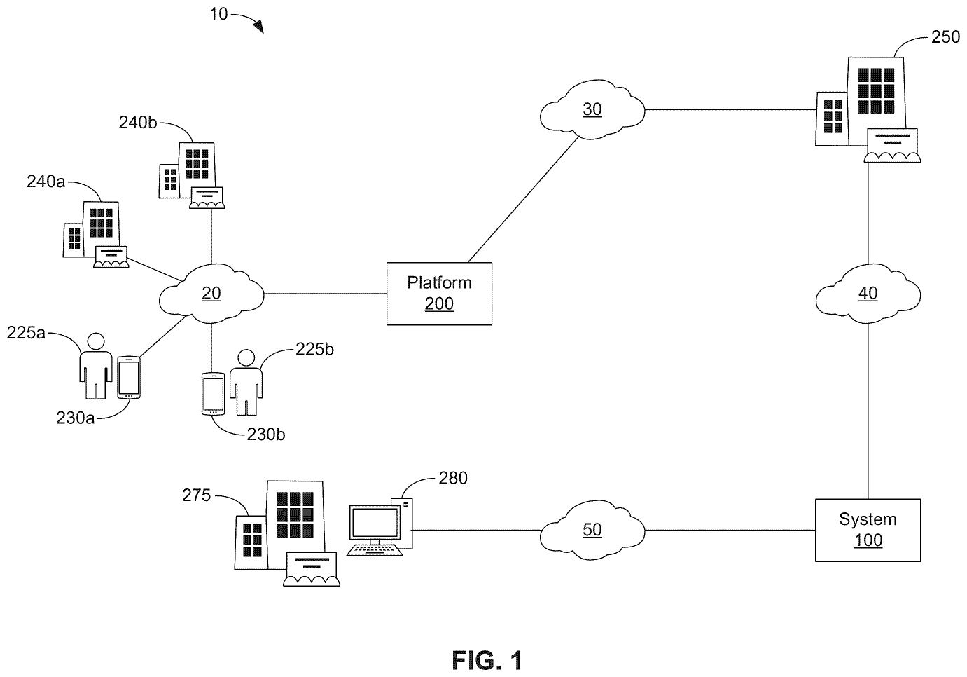

Turning to the figures, FIG. 1 illustrates an example environment 10 in which corporate targets are identified based on social media content in accordance with the teachings herein.

The environment 10 includes a social media platform 200. In the illustrated example, the social media platform 200 is a business- and employment-focused social networking platform, such as LinkedIn®. The environment includes a plurality of social media users of the social media platform 200.

For example, one or more individuals 225 use and interact with the social media platform 200 via a network 20. The network 20 may be a public network, such as the Internet, or a private network, such as an intranet. Each of the individuals 225 interacts with the social media platform 200 via a respective computing device 230. In the illustrated example, each computing device 230 is a smartphone. In other examples, one or more of the computing devices 230 may be a desktop, a laptop, a tablet, a smartwatch, and/or any other computing device capable of accessing a social media platform.

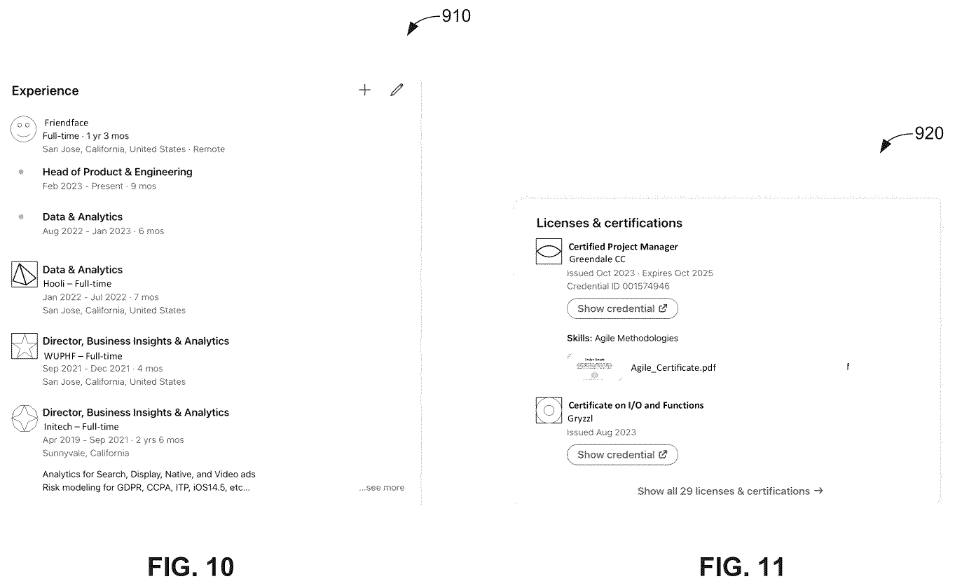

Each of the individuals 225 may have a corresponding profile on the social media platform 200. FIGS. 10-11 depict portions of an example profile for one of the individuals 225 on the social media platform 200. As shown in FIG. 10, a portion 910 of the profile of an individual 225 includes an employment history of the individual 225. For each position held by the individual 225, the employment history may include an employer or company name, a job title, a job description, and a duration of time (e.g., a date range) during which the individual 225 held the respective position. As shown in FIG. 11, a portion 920 of the profile of an individual 225 may also include a list of license(s) and/or certification(s) obtained by the individual 225. The profile may include other information related to the individual 225, such as education, skills, awards, volunteering experience, memberships of organizations, language skills, interests, written publications, patents held, etc.

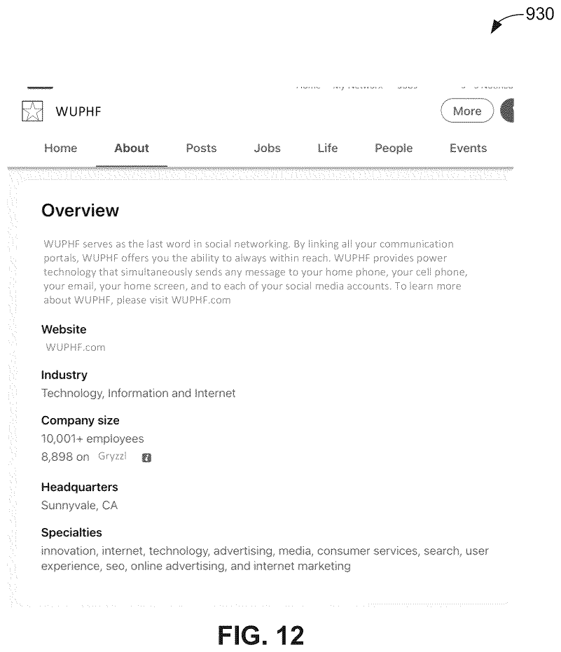

Returning to FIG. 1, one or more companies 240 use and interact with the social media platform 200 via the network 20. Each of the companies 240 may have a corresponding profile on the social media platform 200. FIG. 12 depicts a portion 930 of an example profile for one of the companies 240 on the social media platform 200. In the illustrated example, the profile for one of the companies 240 includes a description or overview of the company 240, contact information (e.g., a website), a brief description of the industry in which the company 240 operates, a size or employee count of the company 240, a location (e.g., a headquarters location) of the company 240, and specialties of the company 240 within the its industries.

Returning again to FIG. 1, the environment 10 also includes a third-party vendor 250. In the illustrated example, the third-party vendor 250 collects social media data from the social media platform 200 via a network 30 and aggregates the collected social media data for subsequent analysis by other parties. The third-party vendor 250 may scrape and/or otherwise obtain publicly-available social media data from the social media platform 200. The network 30 may be a public network, such as the Internet, or a private network, such as an intranet.

For each individual 225, the social media data collected by the third-party vendor 250 may include a name of, the employment history of, and/or any license(s) and/or certification(s) as included in the profile of the individual 225 on the social media platform 200. For each company 240, the social media data collected by the third-party vendor 250 may include a description, a size (e.g., employee count), a location (e.g., of its headquarters), industries of operation, and/or any specialties of the company 240 as included in the profile of the company 240 on the social media platform 200. The collected social media data may be aggregated in a database for other parties or systems, such as a target-identification system 100 of the environment 10 of FIG. 1.

The example target-identification system 100 disclosed herein is configured to obtain the social media data of the social media platform 200. In the illustrated example, the target-identification system 100 collects the social media data from the third-party vendor 250 via a network 40. The network 40 may be a public network, such as the Internet, or a private network, such as an intranet. In other examples, the target-identification system 100 is configured to collect publicly-available social media data directly from the social media platform 200 (e.g., via scraping) and subsequently aggregate the collected data.

The environment 10 also includes a searching company 275 that is interested in targeting another company (e.g., for a merger, acquisition, corporate partnership, customer identification, talent acquisition, competitive landscape, benchmarking, etc.). In the illustrated example, the searching company 275 is communicatively connected via a network 50. The network 50 may be a public network, such as the Internet, or a private network, such as an intranet. In the illustrated example, each of the networks 20, 30, 40, 50 are separate from each other. In other examples, the network 20, the network 30, the network 40, and/or the network 50 are combined as a single network (e.g., the Internet).

As disclosed below in greater detail, the target-identification system 100 is configured to identify one or more target companies for the searching company 275 based on social media content posted on the social media platform 200.

For example, the target-identification system 100 is configured to collect social media data of companies and individuals on the social media platform 200 from the third-party vendor 250 and/or directly from the social media platform 200. For example, the target-identification system 100 is configured to collect an employment history and/or licenses/certifications from a respective profile of each individual on the social media platform 200. The employment history includes a job title, a job description, a company name, and/or a date range for each position identified in the employment history for each individual. The target-identification system 100 also is configured to collect a company name, a company description, and/or company specialties from a respective profile of each company on the social media platform 200.

The target-identification system 100 is further configured to generate data from the collected social media data. The reference data is organized by company, with the reference data for each company including corresponding company information and individual information of current employees. The target-identification system 100 also is configured to identify one or more seed companies that are representative of the type of company the searching company 275 is interested in targeting. For example, the seed companies may have one or more characteristics of interest to the searching company 275.

Based on the identified seed companies and the reference data, the target-identification system 100 is configured to identify a pool of candidate companies included in the reference data. The target-identification system 100 is configured to generate similarity score(s) for each combination of a seed company and a candidate company. Based on the similarity score(s), the target-identification system 100 is configured to identify corporate target(s) for the searching company 275. That is, the target-identification system 100 is configured to generate new data based on social media content that is then analyzed to automatically identify corporate targets for the searching company 275 using a specific set of rules that have not been and likely would not otherwise be implemented by those in search of automated corporate analytics.

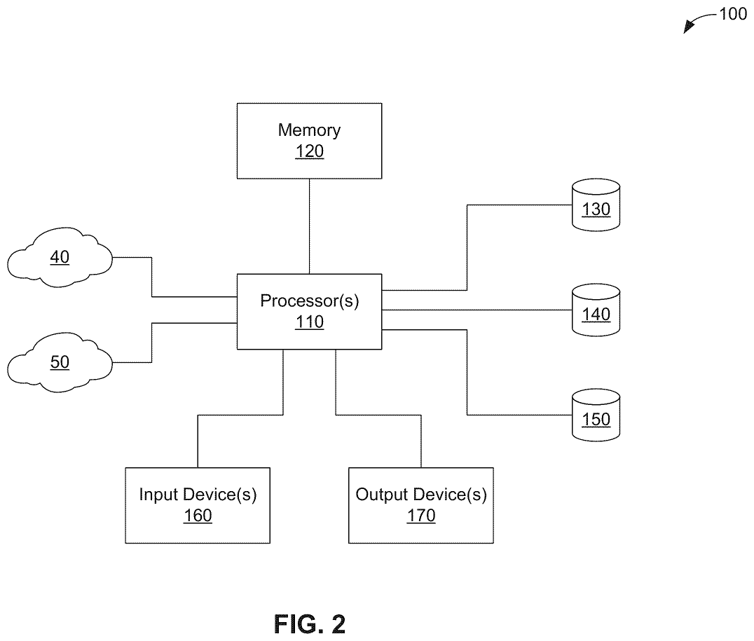

FIG. 2 depicts a block diagram of the target-identification system 100. In the illustrated example, the target-identification system 100 includes one or more processors 110, memory 120, a social media database 130, a reference database 140, a target database 150, one or more input devices 160, and one or more output device 170.

The processor(s) 110 may be any suitable processing device or set of processing devices such as, but not limited to, a microprocessor, a microcontroller-based platform, an integrated circuit, etc. The processor(s) 110 are communicatively connected to the network 40 to collect information, such as social media data, from the social media platform 200 and/or the third-party vendor 250. The processor(s) 110 are communicatively coupled to the network 50 to collect information, such as social media data, from the searching company 275 and to transmit information, such as reports on identified target companies, to the searching company 275.

The memory 120 may include one or more of volatile memory, non-volatile memory, read-only memory, etc. In some examples, the memory 120 may include a combination of multiple kinds of memory, such as volatile memory and non-volatile memory. The memory 120 is computer readable media on which one or more sets of instructions, such as the software for operating the methods of the instant disclosure, can be embedded. The instructions may embody one or more of the methods or logic as described herein. For example, the instructions reside completely, or at least partially, within any one or more of the memory 120, the computer readable medium, and/or within the processor(s) 110 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The input device(s) 160 enable an operator, such as an information technician or analyst of the target-identification system 100, to provide instructions, commands, and/or data to the processor(s) 110. Additionally or alternatively, the input device(s) 160 enable the operator to modify and/or update the instructions stored in the memory 120 and/or data stored in the social media database 130, the reference database 140, and/or the target database 150. Example input device(s) 160 include a keyboard, a mouse, a touch screen, a touchpad, a speech recognition system, an instrument panel, button(s), control knob(s), etc.

The output device(s) 170 display output information and/or data of the target-identification system 100 to an operator, such as an information technician or analyst. Example output device(s) 170 include a liquid crystal display (LCD), an organic light emitting diode (OLED) display, a flat panel display, a solid state display, and/or any other device that visually presents information to a user. Additionally or alternatively, the output device(s) 170 may include one or more speakers and/or any other device(s) that provide audio output signals for the operator. Further, the output device(s) 170 may provide other types of output information, such as haptic signals.

In the illustrated example, each of the social media database 130, the reference database 140, and the target database 150 are separate from each other. In other examples, the social media database 130, the reference database 140, and/or the target database 150 may be combined in the form of a single database. Additionally or alternatively, one or more of the social media database 130, the reference database 140, and/or the target database 150 may collectively be formed by a plurality of different databases.

In operation, the social media database 130 is configured to store social media data of companies and individuals on the social media platform 200 from the third-party vendor 250 and/or directly from the social media platform 200. The social media database 130 of the illustrated example is configured to store data associated with a plurality of different data source types.

For example, a portion the social media database 130 is configured to store data corresponding to companies. Each row or data field of this portion corresponds with a particular company and includes the name and a description of the company. Information related to the description and company name may have been collected from an “about” tab on the profile of the corresponding company on the social media platform 200.

Another portion of the social media database 130 is configured to store data corresponding to company specialties. Each row or data field of this portion corresponds with a particular company specialty and includes the company name and corresponding company specialty. Information related to the company specialty may have been collected from an “about” tab on the profile of the corresponding company on the social media platform 200.

Another portion of the social media database 130 is configured to store data corresponding to job histories of individuals. Each row or data field of this portion corresponds with an individual name, a job title, a job description, a company name, and a date range in which the job was and/or has been held. Information related to a job history of an individual may have been collected from a profile of that individual on the social media platform 200.

Another portion of the social media database 130 is configured to store data corresponding to licenses and/or certifications held by individuals. Each row or data field of this portion corresponds with an individual name, a license and/or certification title, a certification authority, and a date. Information related to the company specialty may have been collected from a “member” page on the profile of the corresponding individual on the social media platform 200.

In some instances, some companies may be difficult to fully differentiate from each other based solely on the social media data collected from the social media platform 200. For instance, it may be difficult to differentiate between some software companies whose description is vague as to what type of software is being developed and/or whose employees predominantly have a similar job title (e.g., software engineer). In such examples, publicly-available data may be collected from the websites (e.g., via a public web scrape) of those companies using a search-based process. Each row or data field of this portion corresponds with a particular company and includes the company name and additional data (e.g., products, services, location, etc.) used to further differentiate those companies.

In the illustrated example, the social media database 130 is a single database that is configured to store the data associated with the companies, the company specialties, the employment histories, the licenses and certifications, the company websites, etc. In other examples, the social media database 130 may be formed by a plurality of databases with each of those databases designated to store a respective one of those data types.

The reference database 140 is configured to store reference data of companies and/or individuals associated with the companies. The reference data is generated by the processor(s) 110 based on the social media data stored in the social media database 130. The reference data stored in the reference database 140 is used by the processor(s) 110 to compare seed companies to candidate companies to generate target data and/or identify target companies for the searching company 275.

To generate the reference data, the processor(s) 110 clean and standardize the format of the social media data. Additionally, rows or data fields corresponding with individuals are grouped, sorted, and associated with the companies by which those individuals are employed (e.g., currently and/or historically).

The processor(s) 110 are configured to generate searchable and comparable data terms from the cleaned and standardized terms and store those data terms as reference data in the reference database 140. For example, the processor(s) 110 are configured to generate data terms in the form of n-grams, which are adjacent words within the data fields. That is, n-grams are collection of n successive words of text within a data field. Example n-grams include 1-grams formed of single words, 2-grams formed of two successive words, 3-grams formed of three successive words, etc. For example, for a job title of “Senior Software Engineering Manager,” the following 1-grams may be formed: “Senior,” “Software,” “Engineering,” and “Manager.” The following 2-grams may be formed: “Senior Software,” “Software Engineering,” and “Engineering Manager.” The following 3-grams may be formed: “Senior Software Engineering” “Software Engineering Manager.”

The reference data stored in the reference database 140 also includes one or more frequency score(s) indicative of how frequently each data term appears within the data of each company for each data type. For example, for a data type of “Current Job Title of Current Employees,” the processor(s) 110 calculate frequency score(s) indicative of how frequently the data term “Software Engineer” appears in the reference data for “Company Y.” The processor(s) 110 also calculate frequency score(s) for each data term that appears in the data for “Company Y” for the data type of “Current Job Title of Current Employees.” Similarly, the processor(s) 110 calculate frequency score(s) for each combination of data type, company, and data term. As disclosed below in greater detail, each frequency score may be in the form of an n-gram count and/or a term frequency-inverse document frequency (TF-IDF).

Further, the processor(s) 110 rank the data terms within each company for each data type based on their respective frequency scores. That is, the reference data stored in the reference database 140 includes rankings of data terms in each data type for each company. For example, for the data type of “Current Job Title of Current Employees” for “Company Y,” the reference data may include the following ranking of data terms based on their frequency of appearance in the data: “1. Officer,” 2. “Account Executive,” “3. Equity Sales,” “4. Branch Sales,” “5. Sales Trader,” etc.

In some examples, the reference database 140 also includes flags or keyword scores associated with one or more feature keywords. A feature keyword may facilitate identification of whether a company and/or individual corresponds with a particular feature associated with the feature keyword. The reference data may include flags indicating which company and/or individual has the corresponding feature. That is, the processor(s) 110 are configured to flag a company and/or individual if the text of a data term of that company and/or individual matches the corresponding feature keyword. Additionally or alternatively, the processor(s) 110 may determine a keyword score for each company that indicates how many data terms of that company match the corresponding keyword. In turn, the reference data stored in the reference database 140 includes a keyword score for each combination of feature keyword and company.

Turning to the target database 150, target data corresponding with candidate companies is stored in the target database 150 by the processor(s) 110. The target data facilitates identification of one or more target companies for the searching company 275.

To generate the target data, the processor(s) 110 identify one or more seed companies that are representative of the type of company the searching company 275 would like to target. The processor(s) 110 also identify one or more prerequisites (e.g., company size, company location, specialty, etc.) to select one or more candidate companies from the companies included in the reference data. The processor(s) 110 may also identify one or more data types represented in the reference data as a data type of interest.

Upon identifying the seed companies and the candidate companies, the processor(s) 110 calculate similarity score(s) for each combination of seed company, candidate company, and data type of interest. That is, for each combination, the processor(s) 110 calculate similarity score(s) that are indicative of how similar the respective candidate company is to the respective seed company based on the respective data type. As disclosed below in greater detail, each similarity score may be in the form of a cosine similarity score or an n-gram overlap score. In some examples, the calculations for the similarity scores may be further dimensionalized by only comparing a number of highest-ranking data terms of the seed company with that of the corresponding candidate company.

The similarity scores are included in the target data stored in the target database 150. Additionally, the target data stored in the target database 150 may also include flags or keyword scores to identify which and to what degree candidate companies are associated with feature keywords.

The processor(s) 110 are then configured to identify target companies based on the similarity scores and/or other target data stored in the target database 150. Upon identifying the target companies, the processor(s) 110 generate a report for and transmit the report to the searching company 275.

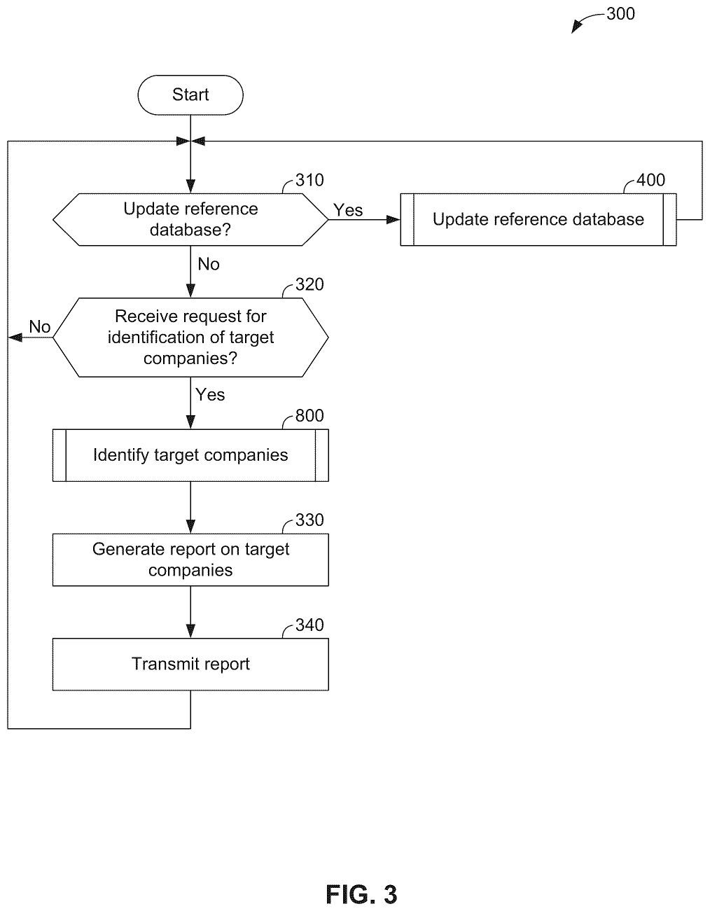

FIG. 3 is a flowchart of an example method 300 for the target-identification system 100 to identify corporate targets based on social media content. The flowchart of FIG. 3 is representative of machine readable instructions that are stored in memory (such as the memory 120 of FIG. 2) and include one or more programs which, when executed by one or more processors (such as the processor(s) 110 of FIG. 2), cause the target-identification system 100 to identify corporate targets. While the example program is described with reference to the flowchart illustrated in FIG. 3, many other methods may alternatively be used. For example, the order of execution of the blocks may be rearranged, changed, eliminated, and/or combined to perform the method 300. Further, because the method 300 is disclosed in connection with the components of FIGS. 1-2, some functions of those components will not be described in detail below.

Initially, at block 310, the processor(s) 110 determine whether the reference database 140 is to be updated. In some examples, the processor(s) 110 update the reference database 140 at a predefined interval (e.g., once a day, once a week, twice a month, etc.). Additionally or alternatively, the processor(s) 110 may update the reference database 140 upon detecting a predefined event, such as identification that the social media database 130 has been updated with new data. Further, in some examples, the processor(s) 110 may update the reference database 140 on demand and/or upon receiving a request from the searching company 275. In response to the processor(s) 110 determining that the reference database 140 is to be updated, the method 300 proceeds to block 400 at which the processor(s) 110 update the reference database 140.

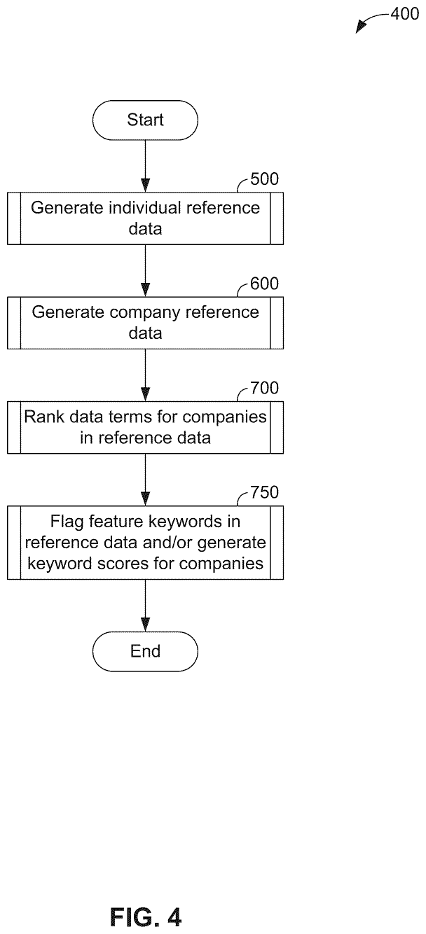

FIG. 4 is a flowchart of an example method 400 for the target-identification system 100 to execute block 400 of FIG. 3 to update the reference database 140. The flowchart of FIG. 4 is representative of machine readable instructions that are stored in memory (such as the memory 120 of FIG. 2) and include one or more programs which, when executed by one or more processors (such as the processor(s) 110 of FIG. 2), cause the target-identification system 100 to update the reference database 140. While the example program is described with reference to the flowchart illustrated in FIG. 4, many other methods may alternatively be used. For example, the order of execution of the blocks may be rearranged, changed, eliminated, and/or combined to perform the method 400. Further, because the method 400 is disclosed in connection with the components of FIGS. 1-2, some functions of those components will not be described in detail below.

Initially, at block 500, the processor(s) 110 generate reference data for the reference database 140 based on social media data of individuals on the social media platform 200.

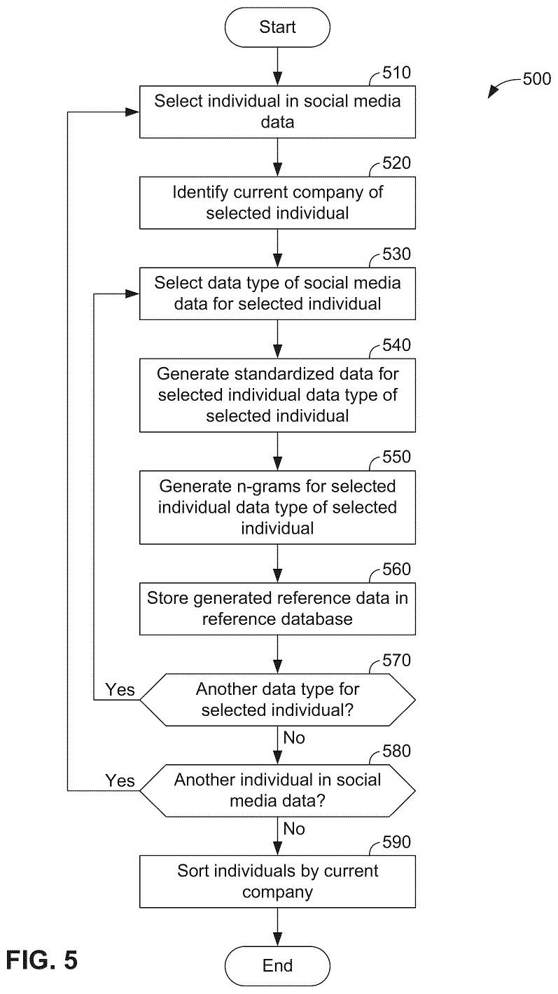

FIG. 5 is a flowchart of an example method 500 for the target-identification system 100 to execute block 500 of FIG. 4 to generate reference data of individuals for the reference database 140. The flowchart of FIG. 5 is representative of machine readable instructions that are stored in memory (such as the memory 120 of FIG. 2) and include one or more programs which, when executed by one or more processors (such as the processor(s) 110 of FIG. 2), cause the target-identification system 100 to generate the individual reference data. While the example program is described with reference to the flowchart illustrated in FIG. 5, many other methods may alternatively be used. For example, the order of execution of the blocks may be rearranged, changed, eliminated, and/or combined to perform the method 500. Further, because the method 500 is disclosed in connection with the components of FIGS. 1-2, some functions of those components will not be described in detail below.

Initially, at block 510, the processor(s) 110 select social media data of an individual in the social media database 130. The social media data for the selected individual may include a job history and/or a list of certifications and/or licenses held by the selected individual. For example, the data includes the following data types for each job identified in the job history: an employer or company name, a job title (e.g., including a current job title and historical job title(s)), a job description (e.g., including a current job description and historical job description(s)), a duration of time (e.g., a date range), etc. The data includes the following data types for each license and/or certification held by the selected individual: a license/certification title, a certification authority, a date, etc.

At block 520, the processor(s) 110 identify the company at which the selected individual is currently employed. For example, the processor(s) 110 identify the company of the individual based on date range(s) in their job history. In some examples, a date range is expressed as a “date from” and “date to” employment. If the “date to” is null for a particular position, the processor(s) 110 determine that the employer corresponding to that particular position is the current employer of the selected individual.

At block 530, the processor(s) 110 select a data type included in the social media data for the selected individual. Example data types include an individual name, an employer or company name, a job title, a job description, a date range of employment, a license/certification title, a certification authority, a certification date, etc.

At block 540, the processor(s) 110 generate searchable and comparable data terms of the selected data type for the selected individual by cleaning and standardizing the form of the corresponding social media data. For example, for the “Job Title” data type(s) (e.g., “Current Job Title” and “Historical Job Title”), the processor(s) 110 remove stop words and/or punctuation and translate any job title in a foreign language to one language (e.g., English). For the “Job Description” data type(s) (e.g., “Current Job Description” and “Historical Job Description”), the processor(s) 110 remove stop words and/or punctuation and translate any job title in a foreign language to one language (e.g., English). For the “Date Range” data type, the processor(s) 110 convert the entry from text form (e.g., February 2005) to date form (e.g., 2005 Feb. 1). For each data field associated with an employment history, the processor(s) 110 determine and annotate the field with “valid” or “invalid” based on information included in the field. For the “Certification Name” and “Certification Authority” data types, the processor(s) 110 remove stop words and/or punctuation. For the “Certification Date” data type, the processor(s) 110 convert the entry from text form to date form.

At block 550, the processor(s) 110 further generate searchable and comparable data terms by generating n-grams for the selected data type of the selected individual. For example, for the data type of “Current Job Title,” the processor(s) 110 generate 1-grams, 2-grams, and/or 3-grams for data terms of the reference data. For the data type of “Current Job Description,” the processor(s) 110 generate 2-grams and/or 3-grams for data terms of the reference data. For the data type of “Historical Job Title,” the processor(s) 110 generate 1-grams and/or 2-grams for data terms of the reference data. For the data type of “Historical Job Description,” the processor(s) 110 generate 2-grams for data terms of the reference data. For the data type of “Certification Authority,” which is indicative of agencies that issued licenses and/or certifications of current employees for each company, the processor(s) 110 generate 1-grams and 2-grams for data terms of the reference data.

At block 560, the processor(s) 110 store the generated reference data of the selected data type for the selected individual in the reference database 140. At block 570, the processor(s) 110 determine whether there is another data type for the selected individual. In response to the processor(s) 110 determining that there is another data type, the method 500 returns to block 530. Otherwise, in response to the processor(s) 110 determining that there is not another data type, the method 500 proceeds to block 580 at which the processor(s) 110 determine whether there is social media data for another individual in the social media database 130. In response to the processor(s) 110 determining that there is another individual, the method 500 returns to block 510. Otherwise, in response to the processor(s) 110 determining that there is not another individual, the method 500 proceeds to block 590.

At block 590, the processor(s) 110 sort the individuals and the corresponding reference data by the current company at which they are employed. That is, the processor(s) 110 group all of the reference data of the individuals that are currently employed by the same company together so that the company employee data can be used when subsequently analyzing features of that company. Additionally or alternatively, the processor(s) 110 may sort data fields corresponding with the “Historical Job Title” and/or “Historical Job Description” data types with the companies associated with those historical jobs.

Upon completing block 590, the method 500 for generating individual reference data ends. In FIG. 5, the blocks are depicted as being performed by the processor(s) 110 in a sequential manner. However, the blocks may be performed by the processor(s) 110 nearly simultaneously such that the reference data is generated, sorted, and stored all at once.

Returning to FIG. 4, the method 400 for updating the reference database 140 proceeds to block 600 upon completing block 500. At block 600, the processor(s) 110 generate reference data for the reference database 140 based on social media data of companies on the social media platform 200.

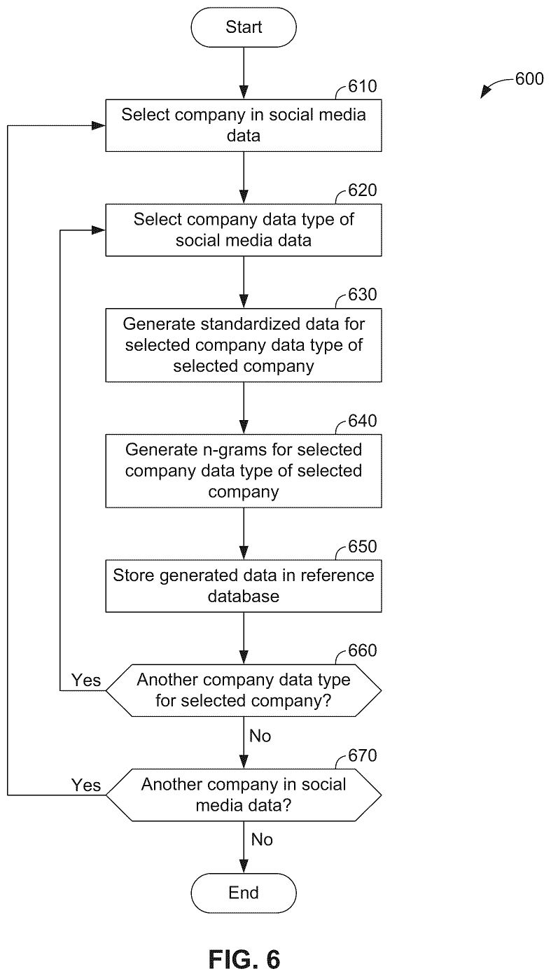

FIG. 6 is a flowchart of an example method 600 for the target-identification system 100 to execute block 600 of FIG. 4 to generate reference data of companies for the reference database 140. The flowchart of FIG. 6 is representative of machine readable instructions that are stored in memory (such as the memory 120 of FIG. 2) and include one or more programs which, when executed by one or more processors (such as the processor(s) 110 of FIG. 2), cause the target-identification system 100 to generate the company reference data. While the example program is described with reference to the flowchart illustrated in FIG. 6, many other methods may alternatively be used. For example, the order of execution of the blocks may be rearranged, changed, eliminated, and/or combined to perform the method 600. Further, because the method 600 is disclosed in connection with the components of FIGS. 1-2, some functions of those components will not be described in detail below.

Initially, at block 610, the processor(s) 110 select social media data of a company in the social media database 130. The social media data for the selected company may include a company name, a company description, company specialties, etc. At block 620, the processor(s) 110 select a data type included in the social media data for the selected company. Example data types include company name, company description, company specialties, etc.

At block 630, the processor(s) 110 generate searchable and comparable data terms of the selected data type for the selected company by cleaning and standardizing the form of the corresponding social media data. For example, for the “Company Description” and “Company Specialty” data types, the processor(s) 110 remove stop words and/or punctuation. Further, in some examples, some companies may be difficult to fully differentiate solely based on the social media data collected from the social media platform 200. In such examples, the processor(s) 110 may generate additional reference data for such companies based on data collected from websites (e.g., via a public web scrape) of those companies using a search-based process.

At block 640, the processor(s) 110 further generate searchable and comparable data terms by generating n-grams for the selected data type of the selected company. For example, for the data type of “Company Specialty,” the processor(s) 110 generate 2-grams for data terms of the reference data.

At block 650, the processor(s) 110 store the generated reference data of the selected data type for the selected company in the reference database 140. At block 660, the processor(s) 110 determine whether there is another data type for the selected company. In response to the processor(s) 110 determining that there is another data type, the method 600 returns to block 620. Otherwise, in response to the processor(s) 110 determining that there is not another data type, the method 600 proceeds to block 670 at which the processor(s) 110 determine whether there is social media data for another company in the social media database 130. In response to the processor(s) 110 determining that there is another individual, the method 600 returns to block 610. Otherwise, in response to the processor(s) 110 determining that there is not another individual, the method 600 for generating individual reference data ends.

In FIG. 6, the blocks are depicted as being performed by the processor(s) 110 in a sequential manner. However, the blocks may be performed by the processor(s) 110 nearly simultaneously such that the reference data is generated, sorted, and stored all at once.

Returning to FIG. 4, the method 400 for updating the reference database 140 proceeds to block 700 upon completing block 600. At block 700, the processor(s) 110 rank data terms for the companies in the reference data of the reference database 140.

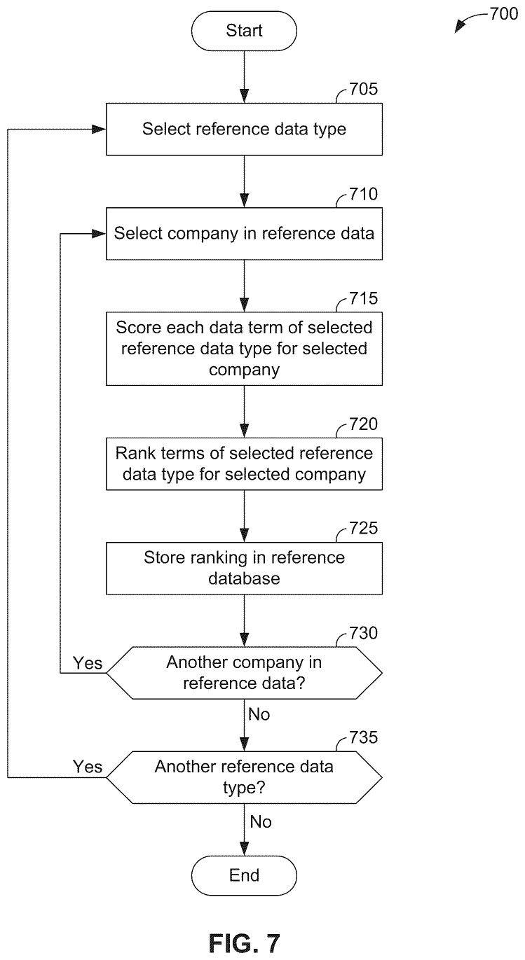

FIG. 7 is a flowchart of an example method 700 for the target-identification system 100 to execute block 700 of FIG. 4 to rank data terms of reference data types for companies in the reference database 140. The flowchart of FIG. 7 is representative of machine readable instructions that are stored in memory (such as the memory 120 of FIG. 2) and include one or more programs which, when executed by one or more processors (such as the processor(s) 110 of FIG. 2), cause the target-identification system 100 to rank data terms of the reference data types for the companies. While the example program is described with reference to the flowchart illustrated in FIG. 7, many other methods may alternatively be used. For example, the order of execution of the blocks may be rearranged, changed, eliminated, and/or combined to perform the method 700. Further, because the method 700 is disclosed in connection with the components of FIGS. 1-2, some functions of those components will not be described in detail below.

Initially, at block 705, the processor(s) 110 select a data type included in the reference data of the reference database 140. At block 710, the processor(s) 110 select a company with one or more data entries in the reference database 140.

At block 715, the processor(s) 110 generates one or more frequency scores for each n-gram data term included in the reference data of the selected company for the selected data type. A frequency score is indicative of how frequently a respective data term is included in the reference data for a respective company.

Example frequency score(s) include n-gram count scores and term frequency-inverse document frequency (TF-IDF) scores. For an n-gram count score, the processor(s) 110 determine how many times a respective n-gram data term appears in the reference data of a respective company for a respective data type. For a TF-IDF score, the processor(s) 110 use term frequency-inverse document frequency (TF-IDF) analysis to determine how prevalent a respective data term is within the reference data of a respective data type for a respective company. By accounting for some words appearing more frequently in text in general, TF-IDF analysis measures how important a term is within a document relative to a collection of documents (i.e., a corpus). With respect to method 700, a TF-IDF score calculated by the processor(s) 110 measures how important a respective n-gram data term is within the reference data of a respective company for a respective data type (e.g., the document) relative to the reference data of all companies for the respective data type (e.g., the corpus).

At block 720, the processor(s) 110 rank the n-gram data terms of the selected data type for the selected company based on their respective frequency scores. At block 725, the processor(s) 110 store the ranking of the n-gram data terms for the selected data type and the selected company in the reference database 140.

At block 730, the processor(s) 110 determine whether there is another company with one or more data entries in the reference data of the reference database 140. In response to the processor(s) 110 determining that there is another company, the method 700 returns to block 710. Otherwise, in response to processor(s) 110 determining that there is not another company, the method 700 proceeds to block 735.

At block 735, the processor(s) 110 determine whether there is another data type in the reference data of the reference database 140. In response to the processor(s) 110 determining that there is another data type, the method 700 returns to block 705. Otherwise, in response to processor(s) 110 determining that there is not another data type, the method 700 for ranking data terms for companies ends.

Returning to FIG. 4, the method 400 for updating the reference database 140 proceeds to block 750 upon completing block 700. At block 750, the processor(s) 110 flag feature keywords in the reference data and/or generate corresponding keyword scores for companies for the reference database 140.

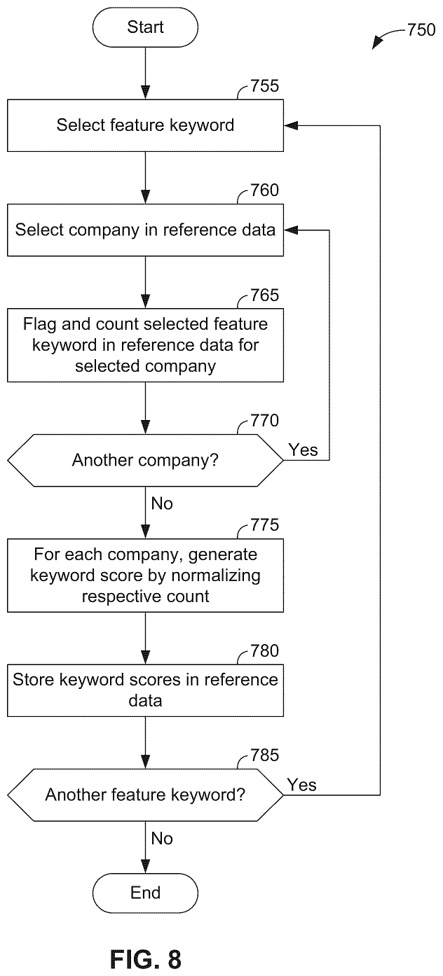

FIG. 8 is a flowchart of an example method 750 for the target-identification system 100 to execute block 750 of FIG. 4 to flag feature keywords in and/or generate keyword scores for the reference database 140. The flowchart of FIG. 8 is representative of machine readable instructions that are stored in memory (such as the memory 120 of FIG. 2) and include one or more programs which, when executed by one or more processors (such as the processor(s) 110 of FIG. 2), cause the target-identification system 100 to flag feature keywords and/or generate keyword scores. While the example program is described with reference to the flowchart illustrated in FIG. 8, many other methods may alternatively be used. For example, the order of execution of the blocks may be rearranged, changed, eliminated, and/or combined to perform the method 750. Further, because the method 750 is disclosed in connection with the components of FIGS. 1-2, some functions of those components will not be described in detail below.

Initially, at block 755, the processor(s) 110 select a feature keyword. At block 760, processor(s) 110 select a company with one or more data entries in the reference database 140. At block 765, the processor(s) 110 determine whether any of the n-gram data terms included in the reference data of the selected company matches and/or otherwise corresponds with the selected feature keyword.

In some examples, the processor(s) 110 match an n-gram data term with a selected feature keyword in response to determining that n-gram data term is identical to the selected feature keyword. The processor(s) 110 may also account for synonyms. For example, the processor(s) 110 may match an n-gram data term with a selected feature keyword in response to determining a normalized version of the n-gram data term is identical to a normalized version of the selected feature keyword. Additionally or alternatively, the processor(s) 110 may first convert the terms into numerical representations (e.g., vectors) or embeddings and then match an n-gram data term with a selected feature keyword in response to determining (e.g., via cosine similarity analysis) that the embeddings of the two are numerically and, therefore, semantically similar.

In response to determining that the reference data of the selected company includes an n-gram data term that matches and/or otherwise corresponds with (e.g., based on synonyms, embeddings of numerical features, etc.) the selected feature keyword, the processor(s) 110 generate a flag designated for the selected feature keyword and store the flag in a data entry of the reference data for the selected company.

Additionally, the processor(s) 110 determine a keyword count by counting how many n-gram data terms of the selected company correspond with the selected feature keyword and/or determine an n-gram count by counting how frequently those different n-gram data terms of the selected company correspond with the selected feature keyword. For example, with a feature keyword of “software,” the keyword count for a selected company may be 2 upon matching with “software engineer” and “software developer” within the reference data of the selected company. The n-gram count may be 40 if, for example, the “software engineer” n-gram appears 25 times and the “software developer” appears 15 times within the reference data of the selected company. The processor(s) 110 also store those count(s) (e.g., a keyword count, an n-gram count) in a data entry of the reference data for the selected company.

At block 770, the processor(s) 110 determine whether there is another company with a data entry in the reference database 140. In response to the processor(s) 110 determining that there is another company, the method 750 returns to block 760. Otherwise, in response to the processor(s) 110 determining that there is not another company, the method 750 proceeds to block 775.

At block 775, the processor(s) 110 generate a respective keyword score for each respective company for the selected feature keyword. In the illustrated example, the processor(s) 110 generate a keyword score for a company by normalizing a corresponding keyword and/or n-gram count compared to the keyword and/or n-gram counts of the other companies. In other examples, the processor(s) 110 assign the keyword and/or n-gram count of the company as the keyword score of that company for the selected feature keyword. At block 780, the processor(s) 110 store the keyword score of each respective company for the selected feature keyword in the reference database 140.

At block 785, the processor(s) 110 determine whether there is another feature keyword. In response to the processor(s) 110 determining that there is another feature keyword, the method 750 returns to block 755. Otherwise, in response to the processor(s) 110 determining that there is not another feature keyword, the method 750 for flagging feature keywords and/or generating keyword scores ends.

Returning briefly to FIG. 4, the method 400 for updating the reference database 140 ends upon completing block 750. In FIG. 4, the blocks are depicted as being performed sequentially by the processor(s) 110. However, the blocks may be performed by the processor(s) 110 nearly simultaneously such that the reference database 140 is updated all at once.

Returning to FIG. 3, the method 300 returns to block 310 upon updating the reference database 140 at block 400. As detailed above, the method 300 proceeds to block 400 to update the reference database 140 in response to the processor(s) 110 determining that reference database 140 is to be updated. Otherwise, in response to the processor(s) 110 determining that the reference database 140 is not to be updated, the method 300 proceeds to block 320.

At block 320, the processor(s) 110 determine whether a request has been received from the searching company 275 to identify target companies. In response to the processor(s) 110 determining that a request has not been received, the method 300 returns to block 310. Otherwise, in response to determining that a request has been received, the method 300 proceeds to block 800 at which the processor(s) identify target companies for the searching company 275.

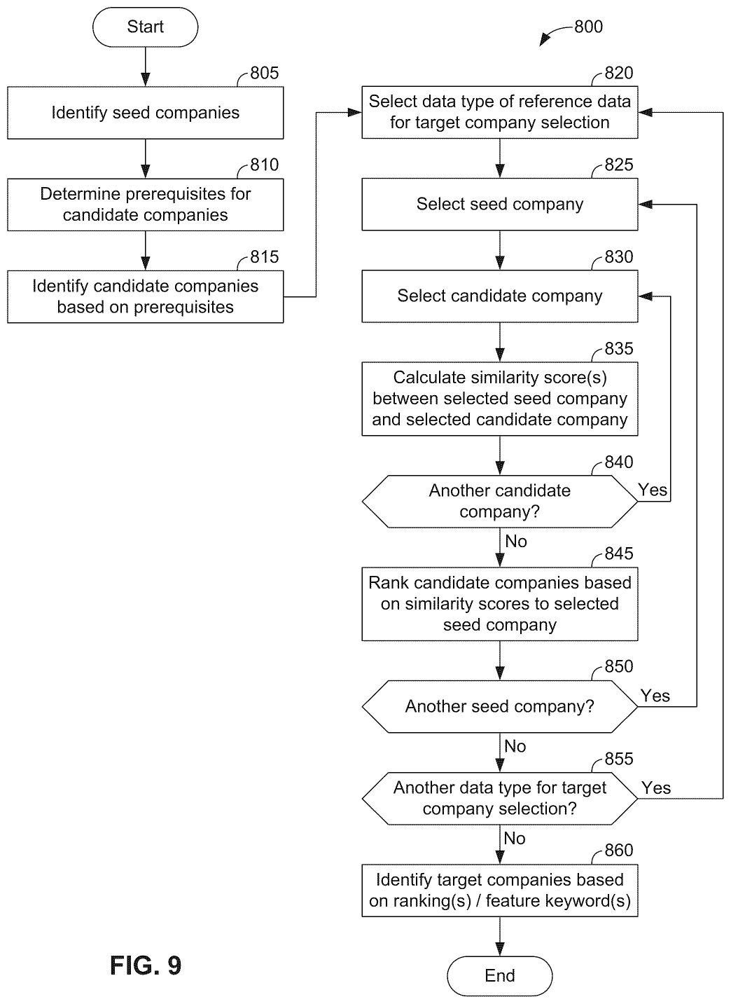

FIG. 9 is a flowchart of an example method 800 for the target-identification system 100 to execute block 800 of FIG. 3 to identify target companies. The flowchart of FIG. 9 is representative of machine readable instructions that are stored in memory (such as the memory 120 of FIG. 2) and include one or more programs which, when executed by one or more processors (such as the processor(s) 110 of FIG. 2), cause the target-identification system 100 to identify target companies. While the example program is described with reference to the flowchart illustrated in FIG. 9, many other methods may alternatively be used. For example, the order of execution of the blocks may be rearranged, changed, eliminated, and/or combined to perform the method 800. Further, because the method 800 is disclosed in connection with the components of FIGS. 1-2, some functions of those components will not be described in detail below.

Initially, at block 805, the processor(s) 110 identify seed companies for the searching company 275. In some examples, the processor(s) 110 receive a list of the seed companies from the searching company 275. In other examples, the processor(s) 110 select or generate the seed companies based on one or more company characteristics of interest provided by the searching company 275.

At block 810, the processor(s) 110 determine prerequisites for subsequently selecting candidate companies for the searching company 275. Example prerequisites include (e.g., country location, employee count, etc.). At block 815, the processor(s) 110 select the candidate companies from the companies included in the reference data based on the predetermined prerequisites. That is, the processor(s) 110 identify a company included in the reference data as a candidate company in response to determining that company satisfies the prerequisites for being a candidate company.

At block 820, the processor(s) 110 select one of the data types included in the reference data that is to be used for identifying target companies for the searching company 275. At block 825, the processor(s) 110 select one of the seed companies. At block 830, the processor(s) 110 select one of the previously-identified candidate companies.

At block 835, the processor(s) 110 calculate one or more similarity scores between the selected seed company and the selected candidate company for the selected data type. The similarity score(s) are calculated based on comparisons between the frequency score(s) in the reference database 140 for the selected seed company and the selected comparison company for the selected data type. Example similarity score(s) include an n-gram overlap score and/or a cosine similarity score.

For an n-gram overlap score, the processor(s) 110 determine how many n-gram data terms of the selected comparison company match those of the selected seed company. That is, the processor(s) 110 count how many data terms are shared between the selected seed company and the selected candidate company for the selected data type. The n-gram overlap score may be further dimensionalized by only comparing a number of highest ranking n-gram data terms (e.g., based on n-gram count scores and/or TF-IDF scores) of the selected candidate company to that of the selected seed company.

In some examples, the processor(s) 110 match an n-gram data term of a selected comparison company with that of a selected seed company in response to determining that n-gram data terms are identical to each other. In some examples, the processor(s) 110 may also account for synonyms. For example, the processor(s) 110 may match an n-gram data term of a selected comparison company with that of a selected seed company in response to determining a normalized version of the n-gram data term of the selected comparison company is identical to a normalized version of that of the selected seed company. Additionally or alternatively, the processor(s) 110 may first convert the data terms into numerical representations (e.g., vectors) or embeddings and then match an n-gram data term of a selected comparison company with that of a selected seed company in response to determining (e.g., via cosine similarity analysis) that the embeddings of the two are numerically and, therefore, semantically similar.

For a cosine similarity score, the processor(s) 110 use cosine similarity analysis to compare the similarity between n-grams of the selected candidate company and those of the selected seed company. Cosine similarity analysis measures the similarity between two vectors. In particular, cosine similarity analysis measures the cosine of the angle formed between the two vectors, which is calculated by dividing the dot product of the two vectors by the product of the lengths of the two vectors. With respect to method 800, one vector includes numerical representations of the n-grams of the selected data type for the selected candidate company and the other vector includes numerical representations of the n-grams of the selected data type of the selected seed company. The cosine similarity score calculated by the processor(s) 110 not only reflects how many shared data terms there are between the selected candidate company and the selected seed company, but also reflects how prevalent those n-grams were for both the selected candidate company and the selected seed company. A cosine similarity score may be calculated based on n-gram count scores and/or TF-IDF scores. The cosine similarity score may be further dimensionalized by only comparing a number of highest ranking n-gram data terms of the selected candidate company to that of the selected seed company.

At block 840, the processor(s) 110 determine whether there is another candidate company to compare to the selected seed company. In response to the processor(s) 110 determining that there is another candidate company, the method 800 returns to block 830 at which the processor(s) 110 select another candidate company. Otherwise, in response to the processor(s) 110 determining that there is not another candidate company, the method 800 proceeds to block 845 at which the processor(s) 110 rank the candidate companies for the selected data type based on the similarity scores to the selected seed company.

At block 850, the processor(s) 110 determine whether there is another seed company. In response to the processor(s) 110 determining that there is another seed company, the method 800 returns to block 825. Otherwise, in response to the processor(s) 110 determining that there is not another seed company, the method 800 proceeds to block 855.

At block 855, the processor(s) 110 determine whether there is another data type to be considered for the selection of target companies. In response to the processor(s) 110 determining that there is another data type, the method 800 returns to block 820. Otherwise, in response to the processor(s) 110 determining that there is not another data type, the method 800 proceeds to block 860.

At block 860, the processor(s) 110 identify one or more target companies from the pool of candidate companies based on the similarity score ranking(s) and/or the feature keyword(s). The processor(s) 110 also store the reference data, similarity scores, corresponding rankings, and/or other data of the target companies and/or other candidate companies in the target database 150.

In some examples, to identify the target companies, the processor(s) 110 select a number of highest scoring candidate companies based on the similarity scores as target companies. In other examples, the processor(s) 110 select any number of candidate companies that have a similarity score greater than a first threshold as a target company. In other examples, the processor(s) 110 select any number of candidate companies that (1) have a similarity score greater than a second threshold and (2) have a keyword score greater than a third threshold as a target company. The second threshold is less than the first threshold.

The processor(s) 110 may select different groups of target companies based on different data types of interest. In other examples, the processor(s) 110 may select one group of target companies based on an averaging of similarity scores across a plurality of data types of interest. Further, the processor(s) 110 may select one group of target companies based on a weighting of a plurality of data types of interest.

By generating different types of one or more types of frequency scores (e.g., n-gram count scores, TF-IDF scores, etc.) for a plurality of different data types (e.g., “Current Job Title,” “Historical Job Title,” “Current Job Description,” “Historical Job Description,” “Date Range,” “Certification Name,” “Certification Authority,” “Certification Date,” “Company Description,” Company Specialty,” etc.) and then generating one or more types of similarity scores (e.g., n-gram overlap scores, cosine similarity scores, etc.) based on those frequency score(s), the processor(s) 110 are able to identify target companies based on a plurality of different combinations of data type(s), frequency score(s), and similarity score(s).

Upon completing block 860, the method 800 for identifying target companies ends. Returning to FIG. 3, the method 300 then proceeds to block 330 at which the processor(s) 110 generate a report on the target companies and/or other candidate companies for the searching company 275 based on the target data stored in the target database 150.

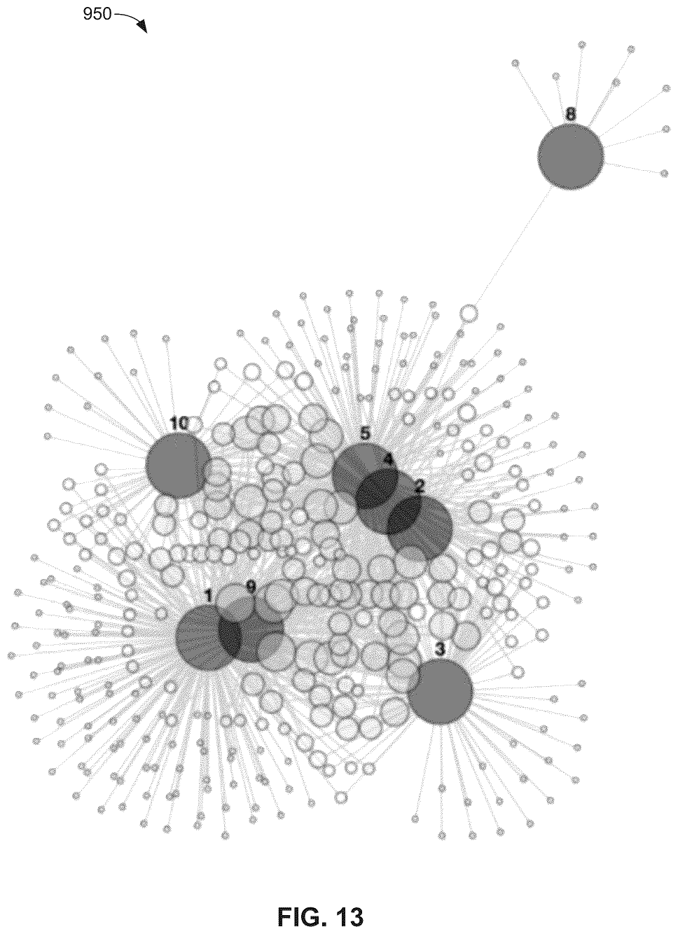

For example, the report generated by the processor(s) 110 includes target data of the target companies and/or other candidate companies represented in the target database 150. In some examples, the report includes a network graph to facilitate members of the searching company 275 in visualizing the relationships between the seed companies and the target companies and/or other candidate companies. FIG. 13 is an example network graph 950. In the illustrated example, the seed companies are represented by dark gray circles, and the target companies are represented by transparent circles. The size of the transparent circles indicate how many seed companies matched with the respective target company. Lines extending from the seed companies indicate similarities between those seed companies and respective candidate companies (e.g., including the target companies). In some examples, lines extend between circles of two seed companies to illustrate a relationship between those seed companies. Additionally or alternatively, lines may extend between circles of two candidate companies to illustrate a relationship between those candidate companies. Further, in some examples, the network graph 950 may include additional circles depicting the most prevalent n-gram data terms, with lines extending between the n-gram circles and those of candidate and/or seed companies to depict which n-gram data terms connect the candidate and/or seed companies together.

Additionally or alternatively, the report generated by the processor(s) 110 may include appended meta data of the target companies and/or other candidate companies that facilitates the searching company 275 in identified a particular target company of interest. The metadata may include information about each particular company (e.g., a website, a description, an industry, a company headquarters country, an employee count on the social media platform 200, a founding year, a size band, affiliated companies, etc.). For example, the metadata may include information about each company's performance and/or other characteristics (e.g., net headcount growth, hiring rate, attrition rate, an estimated percentage of employees that are female, a “signal score” comparing a number of individual-identified employees with a number of company-reported employees, etc.) that is estimated based on public profiles. The metadata may also include information corresponding to each private company's most recent round of funding activity (e.g., type, amount, date, etc.).

At block 340, the processor(s) 110 transmit the report to the searching company 275 via the network 280. For example, the processor(s) 110 may generate the report in the form of a webpage, a portal page, a pdf, a spreadsheet, etc. The processor(s) 110 may transmit the report to the searching company 275 via an email, a text message, a link, a notification, etc. Upon completing block 340, the method 300 returns to block 310.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A system for selecting corporate targets based on social media content, the system comprising:
one or more databases configured to store social media data of users of a social media platform, wherein the users include individuals and companies, and wherein each user has a user profile on the social media platform; and
one or more processors configured to:
for each individual, generate individual data terms from the user profile of the individual and identify a current employer based on the user profile;
for each company:
generate company data terms from the user profile of the company; and
add the individual data terms of the individuals for which the company is identified as the current employer to the company data terms of the company;
for each combination of company and company data term, generate a frequency score for the company that is indicative of how often the company data term is used with respect to the company;
identify one or more seed companies and a pool of candidate companies from the companies on the social media platform;
identify one or more data-types-of-interest for determining one or more target companies from the pool of candidate companies;
for each data-type-of-interest, calculate a respective similarity score for each combination of seed company and candidate company;
determine the one or more target companies based on similarity scores of each candidate company; and
generate and transmit a report for the one or more target companies.

2. The system of claim 1, wherein the one or more databases are further configured to store each frequency score and each similarity score.

3. The system of claim 1, wherein each frequency score includes at least one of an n-gram count or a term frequency-inverse document frequency (TF-IDF) score.

4. The system of claim 1, wherein the one or more processors are configured to identify the pool of candidate companies by determining which of the companies of the social media platform satisfies one or more prerequisites for comparison to the one or more seed companies.

5. The system of claim 1, wherein, for each combination of company and data type, the one or more processors are configured to generate a ranking of the company data terms based on the respective frequency scores.

6. The system of claim 5, wherein, to calculate the similarity score for each combination of seed company and candidate company, the one or more processors are configured to only compare a predetermined number of the company data terms that are highest ranked in the ranking of the respective seed company.

7. The system of claim 1, wherein each similarity score includes at least one of an n-gram overlap score or a cosine similarity score.

8. The system of claim 1, wherein, to determine the target companies, the one or more processors are configured to:
select a predetermined number of the candidate companies with respective highest similarity scores; or
select each of the candidate companies that have a similarity score greater than a threshold score.

9. A method for selecting corporate targets based on social media content, the method comprising:
storing, via one or more databases, social media data of users of a social media platform, wherein the users include individuals and companies, and wherein each user has a user profile on the social media platform;
generating, for each individual via one or more processors, individual data terms from the user profile of the individual and identify a current employer based on the user profile;
generating, for each company via the one or more processors, company data terms from the user profile of the company;
adding, for each company via the one or more processors, the individual data terms of the individuals for which the company is identified as the current employer to the company data terms of the company;
generating, for each combination of company and company data term via the one or more processors, a frequency score for the company that is indicative of how often the company data term is used with respect to the company;
identifying, via the one or more processors, one or more seed companies and a pool of candidate companies from the companies on the social media platform;
identifying, via the one or more processors, one or more data-types-of-interest for determining one or more target companies from the pool of candidate companies;
calculating, for each data-type-of-interest via the one or more processors, a respective similarity score for each combination of seed company and candidate company;
determining, via the one or more processors, the one or more target companies based on similarity scores of each candidate company; and
generating and transmitting, via the one or more processors, a report for the one or more target companies.

10. The method of claim 9, wherein each frequency score includes at least one of an n-gram count or a term frequency-inverse document frequency (TF-IDF) score.

11. The method of claim 9, further comprising generating a ranking of the company data terms based on the respective frequency scores for each combination of company and data type, and wherein calculating the similarity score for each combination of seed company and candidate company includes only comparing a predetermined number of the company data terms that are highest ranked in the ranking of the respective seed company.

12. The method of claim 9, wherein each similarity score includes at least one of an n-gram overlap score or a cosine similarity score.

13. The method of claim 9, wherein determining the target companies includes:
selecting a predetermined number of the candidate companies with respective highest similarity scores; or
selecting each of the candidate companies that have a similarity score greater than a threshold score.

14. A computer readable medium comprising instructions, which, when executed, cause a machine to:
store social media data of users of a social media platform, wherein the users include individuals and companies, and wherein each user has a user profile on the social media platform;
generate, for each individual, individual data terms from the user profile of the individual and identify a current employer based on the user profile;
generate, for each company, company data terms from the user profile of the company;
add, for each company, the individual data terms of the individuals for which the company is identified as the current employer to the company data terms of the company;
generate, for each combination of company and company data term, a frequency score for the company that is indicative of how often the company data term is used with respect to the company;
identify one or more seed companies and a pool of candidate companies from the companies on the social media platform;
identify one or more data-types-of-interest for determining one or more target companies from the pool of candidate companies;
calculate, for each data-type-of-interest, a respective similarity score for each combination of seed company and candidate company;
determine the one or more target companies based on similarity scores of each candidate company; and
generate and transmit a report for the one or more target companies.

15. The computer readable medium of claim 14, wherein each frequency score includes at least one of an n-gram count or a term frequency-inverse document frequency (TF-IDF) score.

16. The computer readable medium of claim 14, wherein, to identify the pool of candidate companies, the instructions, when executed, cause the machine to determine which of the companies of the social media platform satisfies one or more prerequisites for comparison to the one or more seed companies.

17. The computer readable medium of claim 14, wherein, the instructions, when executed, further cause the machine to generate, for each combination of company and data type, a ranking of the company data terms based on the respective frequency scores.

18. The computer readable medium of claim 17, wherein, to calculate the similarity score for each combination of seed company and candidate company, the instructions, when executed, cause the machine to only compare a predetermined number of the company data terms that are highest ranked in the ranking of the respective seed company.

19. The computer readable medium of claim 14, wherein each similarity score includes at least one of an n-gram overlap score or a cosine similarity score.

20. The computer readable medium of claim 14, wherein, to determine the target companies, the instructions, when executed, cause the machine to:
select a predetermined number of the candidate companies with respective highest similarity scores; or
select each of the candidate companies that have a similarity score greater than a threshold score.
